(19) United States
(12) Patent Application Publication
(10) Pub. No.: US 2005/0215655 A1
(43) Pub. Date: Sep. 29, 2005

(54) Anaerobic pressure sensitive adhesive

(76) Inventor: Wayne Louis Bilodeau, Mentor, OH (US)

Correspondence Address: RENNER, OTTO, BOISSELLE & SKLAP, LLP, 1621 EUCLID AVE, 19TH FL, CLEVELAND, OH, 44115-2191, US

(21) Appl. No.: 11/067,805

(22) Filed: Feb. 28, 2005

Related U.S. Application Data
(60) Provisional application No. 60/557,321, filed on Mar. 29, 2004.

(51) Int. Cl. C08G 2/00

(52) U.S. Cl. 522/7

(57) ABSTRACT

A structural adhesive is formed by applying an adhesive composition to a substrate, partially curing the adhesive to a pressure sensitive adhesive, and subsequently curing the adhesive by exposing the adhesive to an anaerobic accelerator in the absence of oxygen. The pressure sensitive adhesive provides a tacky surface allowing a temporary bond at room temperature. Upon curing of the adhesive construction, the bond properties change to that of a structural adhesive, providing a strong permanent bond.

This application claims the benefit of provisional application Ser. No. 60/557,321 filed on Mar. 29, 2004, which is hereby incorporated herein by reference in its entirety.

### TECHNICAL FIELD OF THE INVENTION

This invention relates to anaerobic pressure sensitive adhesives, and more particularly, to acrylic based pressure sensitive adhesives having an ultraviolet curable component and an anaerobic curing component.

### BACKGROUND OF THE INVENTION

Structural adhesives are well known for providing strong and permanent bonds. However, before curing, such adhesives do not normally provide aggressive adhesive qualities and, therefore, require external aids such as clamping devices to hold the substrates to be bonded together until cure has been completed and a structural bond formed.

Pressure sensitive adhesive have been known and have been used in various bonding and fastening applications. They provide a flexible bond and are used in a wide range of applications. However, pressure sensitive adhesives show substantially lower strength characteristics compared to structural adhesives.

Several attempts have been made to obtain a pressure sensitive adhesive that changes into a structural adhesive after heat activation.

U.S. Pat. No. 3,326,741 to Olson discloses a tacky pressure-sensitive adhesive which, upon heat activation, achieves a strong permanent bond. The patent discloses a nitrile rubber/epoxy resin blend with curing agent, such as dicyandiamide. However, the films did not show good cohesive strength at room temperature, which is typically required for a pressure-sensitive adhesive.

U.S. Pat. No. 3,639,500 to Muny and assigned to Avery Dennison Corporation discloses a curable pressure-sensitive adhesive composition containing a polyepoxide, a carboxylated diene polymer, and an acrylic ester tackifier which, upon heat activation, provides a structural bond.

U.S. Pat. No. 4,404,246 to Charbonneau et. al discloses an alkoxylated amino formaldehyde condensate in an acrylic pressure-sensitive adhesive composition as a latent crosslinking agent to improve the cohesive strength after heat activation. However, the material behaves as a highly crosslinked pressure-sensitive adhesive after heat activation and cannot be used for structural bonding.

U.S. Pat. No. 4,452,955 to Boeder discloses an adhesive composition consisting of a polymer dissolved in polymerizable monomer, an accelerator such as organic sulfimides and perfluoroalkylsulfonanilides, and an inhibitor. The adhesive shows pressure-sensitive adhesive properties, and after heat activation, the adhesive demonstrates properties similar to a structural adhesive. However, the properties as detailed in the examples do not show properties of true structural type adhesives, especially in lap shear.

U.S. Pat. No. 4,404,345 to Janssen also discloses a similar adhesive composition consisting of an adhesive base as the first component and an initiator portion as the second component. Bonding methods are also described.

U.S. Pat. No. 5,593,759 to Vargas et al. and assigned to Avery Dennison Corporation discloses a pressure sensitive adhesive that can be heat cured to form the strong and permanent bond of a structural adhesive.

None of the prior art described above describes a pressure-sensitive adhesive that can be anaerobically cured to form the strong and permanent bond of a structural adhesive.

Anaerobic adhesive systems are those that are stable in the presence of oxygen, but will polymerize in the absence of oxygen. Polymerization is generally initiated by the presence of a peroxy compound. Typical anaerobic compositions include (meth)acrylic functional monomers, or prepolymers with acrylate or methacrylate ester groups, especially poly(meth)acrylic functional monomers, organic hydroperoxy or perester initiators, accelerators and stabilizers.

### SUMMARY OF THE INVENTION

A structural adhesive is formed by applying an adhesive composition to a substrate, partially curing the adhesive to a pressure sensitive adhesive, and subsequently curing the adhesive by exposing the adhesive to an anaerobic accelerator in the absence of oxygen. The pressure sensitive adhesive provides a tacky surface allowing a temporary bond at room temperature. Upon curing of the adhesive construction, the bond properties change to that of a structural adhesive, providing a strong permanent bond.

In one aspect, this invention relates to an adhesive comprising, (a) a UV curable component comprising at least one acrylate functional group, (b) a Type II photoinitiator, (c) an amine synergist, (d) an anaerobic curable component comprising at least one methacrylate functional group, and (e) a peroxy initiator. The adhesive may further comprise a tackifier and additional polymerizable components, both UV curable and anaerobically curable.

In another aspect, this invention relates to an adhesive article comprising: a substrate having an upper surface and a lower surface; and an adhesive layer having an upper surface and a lower surface, wherein the adhesive comprises (a) a UV curable component comprising at least one acrylate functional group; (b) a Type II photoinitiator; (c) an amine synergist; (d) an anaerobic curable component comprising at least one methacrylate functional group; and (e) a peroxy initiator, wherein the upper surface of the adhesive layer is adhered to the lower surface of the substrate.

In a further aspect, this invention relates to a method of forming a structural bond comprising: (a) providing a first substrate having an adhesive layer adhered thereto, the adhesive layer comprising a partially UV cured adhesive composition comprising a UV curable component and an anaerobic curable component; (b) applying the adhesive layer of the first substrate to a second substrate wherein the adhesive layer provides an initial adhesion to the surface of the second substrate with light pressure; and (c) orienting the first and second substrates to create a generally anaerobic environment wherein the adhesive layer is disposed within the anaerobic environment.

Adhesive constructions prepared in accordance with the present invention are characterized by exhibiting pressure sensitive properties useful during assembly and which may then be converted by subsequent treatment to a structural adhesive. The adhesive constructions are suitable for a wide variety of applications, including preparation of label constructions.

### DESCRIPTION OF THE INVENTION

The present invention provides an adhesive construction characterized by having high initial bond strength due to the presence of a pressure sensitive adhesive component and high ultimate bond strength as a consequence of the subsequent cure of an anaerobic resin component. The adhesive is normally tacky and forms a pressure sensitive at room temperature and which anaerobic activation is supplanted by a structural adhesive bond. The adhesive construction is prepared by providing (a) a UV curable component comprising at least one acrylate functional group, (b) a Type II photoinitiator, (c) an amine synergist, (d) an anaerobic curable component comprising at least one methacrylate functional group, and (e) a peroxy initiator.

The adhesive composition is coated on a substrate and subjected to a first cure by irradiating the adhesive coated substrate with ultraviolet (UV) radiation. The resulting adhesive layer provides initial tack. The adhesive characteristics of the adhesive construction are further modified by exposing the adhesive to an anaerobic accelerator in the absence of oxygen (air).

In one embodiment, the UV curable component of the adhesive comprises at least one acrylate monomer. Alkyl acrylates that may be used in the present invention have straight chain alkyl groups, branched chain alkyl groups, or cyclic alkyl groups and, preferably, contain from 1 to about 12 carbon atoms. In one embodiment, the alkyl acrylate monomers have from about 4 to about 8 carbon atoms. Such monomers are generally commercially available as commodity chemicals and are less expensive than longer chain alkyl acrylates. They also tend to yield copolymers having a good balance of tack and peel.

A representative, but nonlimiting list of alkyl acrylates useful in the practice of the present invention includes methyl acrylate, ethyl acrylate, n-propyl acrylate, isopropyl acrylate, n-butyl acrylate, isobutyl acrylate, n-amyl acrylate, isoamyl acrylate, n-hexyl acrylate, isohexyl acrylate, cyclohexyl acrylate, isooctyl acrylate, 2-ethylhexyl acrylate, nonyl acrylate, decyl acrylate, lauryl acrylate, stearyl acrylate, isobornyl acrylate, and mixtures thereof.

Other monomers that can be used in the present invention include ethylenically unsaturated monofunctional or multifunctional monomers or a blend thereof. Suitable monofunctional ethylenically unsaturated monomers include ethoxyethoxyethyl acrylate, N-vinyl caprolactam and N-vinyl-2-pyrrolidone and ethoxylated and propoxylated monomers of the monomers listed above and mixtures thereof. Examples of suitable multifunctional ethylenically unsaturated monomers include the acrylic monomers ethylene glycol diacrylate, propylene glycol diacrylate, trimethylolpropane triacrylate, 1,6-hexamethylene dioldiacrylate, pentaerythritol di-, tri-, and tetraacrylate and 1,12-dodecanedioldiacrylate, and mixtures thereof.

Commercially available acrylate functional resins may be used in the present invention. Such resins may contain, in addition to the acrylate functional monomer, a tackifier. Useful acrylate monomer and tackifier blends are available under the trade designation CN3002 and CN3004 from Sartomer Company.

In one embodiment, the pressure sensitive adhesive component comprises a urethane acrylate oligomer, comprising an acrylate group, urethane groups and a backbone. The backbone is derived from a polyol that has been reacted with a diisocyanate and hydroxyalkylacrylate. Examples of suitable polyols are polyether polyols, polyester polyols, acrylic polyols, and other polyols. These polyols can be used either individually or in combinations of two or more.

Examples of the polyisocyanate used for the oligomer are 2,4-toylene diisocyanate, 2,6-tolylene diisocyanate, 1,3-xylylene diisocyanate, 1,4-xylylene diisocyanate, 1,5-naphthalene diisocyanate, m-phenylene diisocyanate, p-phenyl diisocyanate, 3,3′-dimehtyl-4,4′-diphenylmethane diisocyanate, 4,4′-diphenylmethane diisocyanate, 1,6-hexane diisocyanate, isophorone diisocyanate, methylenebis(4-cyclohexylisocyanate), 2,2,4-trimethylhexamethylene diisocyanate, bis(2-isocyanato-ethyl)fumarate, 6-isopropyl-1,3-phenyl diisocyanate, 4-diphenylpropane diisocyanate, hydrogenated diphenylmethane diisocyanate, hydrogenated xylylene diisocyanate, tetramethyl xylylene diisocyanate, lysine isocyanate, and the like. These polyisocyanate compounds may be used either individually or in combinations of two or more.

Examples of the hydroxyl group-containing acrylate used in the oligomer, include, acrylates derived from acrylic acid and epoxy and acrylates comprising alkylene oxides, more in particular, 2-hydroxy ethyl acrylate, 2-hydroxypropylacrylate and 2-hydroxy-3-oxyphenylacrylate. Methacrylate functional groups may also be used, but acrylate functional groups are preferred over methacrylates.

A commercially available urethane acrylate oligomer is BR3042 from Bomar Specialties Company, which is described as an aromatic difunctional polyether urethane acrylate. Other oligomers that can be used include polyester acrylate, epoxy acrylate, polyamide acrylate, siloxane polymer having an acryloyloxy group, a reactive polymer obtained by reacting acrylic acid and a copolymer of glycidyl acrylate and other polymerizable monomers and the like.

In addition to the above-described components, other curable oligomers, polymers and monomers may be added to the UV curable resin composition to the extent that the UV curing characteristics of the resin are not adversely affected.

The adhesive composition contains at least one Type II photoinitiator. Type II photoinitiators are also known as hydrogen-abstracting photoinitiators. Examples of suitable Type II photoiniators include, but are not limited to, benzophenone; benzil (dibenzoyl); xanthone; Michler's ketone; coumarin; acetophenone; thioxanthone; substituted acetophenones such as 2,2-diethoxyacetophenone, 2,2-dimethoxy-2-phenyl-1-p-henylethanone, dimethoxyhydroxyacetophenone, 2-hydroxy-2-methylphenylpropan-1-one, and m-chloroacetophenone; isopropyl thioxanthone (ITX); pentadione; thioxanthrenequinone (TXAQ); 2,3-butanedione (diacetyl); phenanthrenequinone (PAQ); ethylanthraquinone (EAQ); 1,4-chrysenequinone; anthraquinone (AQ); camphorquinone (CQ); pyrene (benzophenanthrene); and benzanthrone. Combinations of these hydrogen abstracting photoinitiators and mixtures of these photoinitiators with other photoinitiators may also be useful.

Useful commercially available photoinitiators include benzophenone available under the trade designations DAROCUR BP from Ciba; PHOTOCURE 81, a 50/50 blend of 4-methyl-benzophenone and benzophenone, from Aceto Corporation; SR1135 from Sartomer, which is a blend of phosphine oxide, trimethyl benzophenone, methylbenzophenone and oligo phenyl propanones; and IRGACURE 500 from Ciba, which is a 50/50 blend of 1-hydroxy-cyclohexyl-phenyl-ketone and benzophenone.

The amount of photoinitiator added to the adhesive composition depends on several factors, including the amount of acrylate added, the coat weight (thickness) of the adhesive layer on the substrate, the web speed during curing and the type of photoinitiator used.

Type II photoinitiators are generally used together with an amine synergist. Particularly suitable amine synergists include monomer tertiary amine compounds, oligomer (polymer) tertiary amine compounds, polymerizable amino acrylate compounds, polymerized amino acrylate compounds and mixtures thereof.

Examples of tertiary amine compounds include dibutylamineoethanol amine, methyldiethanolamine, triethanolamine, triethylamine, aminobenzoates, alkylanilines and acrylated amines. A representative, but nonlimiting list of tertiary amines include N,N-dimethylaminopropyl methacrylamide (DMAPMA), N,N-diethylaminopropyl methacrylamide (DEAPMA), N,N-dimethylaminoethyl acrylate (DMAEA), N,N-diethylaminoethyl acrylate (DEAEA), N,N-dimethylaminopropyl acrylate (DMAPA), N,N-diethylaminopropyl acrylate (DEAPA), N,N-dimethylaminoethyl methacrylate (DMAEMA), N,N-diethylaminoethyl methacrylate (DEAEMA), N,N-dimethylaminoethyl acrylamide (DMAEAAm), N,N-dimethylaminoethyl methacrylamide (DMAEMAAm), N,N-diethylaminoethyl acrylamide (DEAEAAm), N,N-diethylaminoethyl methacrylamide (DEAEMAm), 4-(N,N-dimethylamino)-styrene (DMAS), 4-(N,N-diethylamino)-styrene (DEAS), N,N-dimethylaminoethyl vinyl ether (DMAEVE), and N,N-diethylaminoethyl vinyl ether (DEAEVE).

Commercially available amine synergists include EBECRYL P104, EBECRYL P115 and EBECRYL 7100 from UCB Radcure; PHOTOMER 4967 and PHOTOMER 4770 from Cognis Corporation; CN383 and CN384 from Sartomer; and LAROMER LR 8956 from BASF.

By the term “anaerobic adhesive,” there is meant a mixture of an anaerobic resin system and a catalyst system. By a catalyst system there is meant an acid or base catalyzed system typically containing at least one peroxy initiator. Typical of the peroxy compounds that may be employed as initiators are the hydroperoxides, including organic hydroperoxides of the formula R′OOH, wherein R′ is generally a hydrocarbon radical containing up to 18 carbon atoms, such as alkyl, aryl or aralkyl radical containing from 1 to about 12 carbon atoms.

The anaerobic resin systems are well known to those skilled in the art. Anaerobic curing compositions are formulated such that they are air stabilized but readily polymerize in the absence of oxygen. U.S. Pat. Nos. 3,970,505; 3,993,815; 3,996,308; 4,039,705; 4,092,374; 4,118,442; 4,990,281; 6,013,750; 6,096,842 and 6,583,289, which describe anaerobic resins are incorporated in their entirety herein by reference.

In one embodiment, the anaerobic resin system comprises at least one methacrylate, i.e., the reactive component consists predominantly of an ester of methacrylic acid. Monofunctional methacrylate esters (esters containing one methacrylate group) also may be used. Particularly useful are the methacrylate esters having a relatively polar moiety. Polar groups may be selected from labile hydrogen, heterocyclic ring, hydroxy, amino, cyano, and halogen polar groups; examples include, cyclohexyl methacrylate, tetrahydrofurfuryl methacrylate, hydroxyethyl methacrylate, hydroxypropyl methacrylate, t-butylaminoethyl methacrylate, cyanoethylmethacrylate, and chloroethyl methacrylate. The methacrylate esters can be incorporated as reactive diluents capable of copolymerizing with various other polymerizable materials.

Suitable epoxy-acrylate resins useful in the present invention include those having one or more functional oxiranyl (oxirane) groups and an acrylic-based resin formed from alkylene glycol diacrylate monomers. Such alkylene glycol diacrylate monomers can be selected from mono-, di-, tri-, tetra- and polyethylene glycol dimethacrylate; dipentamethylene glycol dimethacrylate; diglycerol tetramethacrylate; and butylene glycol dimethacrylate. Additional suitable methacrylic-based resin systems include trimethylol propane trimethacrylate, 1,2-butylene glycoldiacrylate, trimethylopropane ethoxylate trimethacrylate, glyceryl propoxylate trimethacrylate, trimethylolpropane trimethacrylate, dipentaerythritol monohydroxy pentamethacrylate, tripropylene glycol dimethacrylate, neopentyl glycol propoxylate dimethacrylate, 1,4-butanediol dimethacrylate, polyethylene glycol dimethacrylate, triethyleneglycol dimethacrylate, butylene glycol dimethacrylate, ethoxylated bisphenol A dimethacrylate, combinations thereof, and the like.

Yet other suitable resins include urethane-methacrylate type monomers, such as urethane-methacrylate-capped prepolymers based on polybutadiene polyols or polyamines and methacrylates such as those disclosed hereinabove.

Urethane methacrylate anaerobically curable resins are available commercially under the trade designation SPEEDBONDER 326 and SPEEDBONDER 324 from Henkel Loctite.

The adhesive system of the present invention may contain one or more additives including a flexibilizer, a plasticizer, a stabilizer and/or a tackifier. In one embodiment, the flexibilizer is a thermoplastic polymer, for example, polyvinyl chloride, polyvinyl ethers, polyvinyl acetates, acrylic based polymers, polyurethanes, polyesters, polyamides, natural and synthetic elastomers and the like, as well as mixtures thereof.

In one embodiment, the adhesive composition further comprises a vinyl-terminated liquid rubber. Examples of vinyl-terminated liquid rubber include liquid polybutadienes and/or liquid polyisoprenes and copolymers thereof. Polyether or polyester polyols and other oligomeric materials with vinyl functional terminal groups are useful. Particularly useful are methacrylate terminated polybutadiene acrylonitrile copolymers such as HYCAR VTBN and HYCAR VTBNX from Noveon, and methacrylate-terminated polybutadiene such as HYCAR VTB from Noveon and RICACRYL 3801 from Sartomer.

A suitable plasticizer can be a high-boiling temperature solvent or a softening agent. An example of a suitable plasticizer is an ester made from an anhydride or acid and a suitable alcohol having from about 6 carbon atoms to about 13 carbon atoms. Other suitable plasticizers include adipate, phosphate, benzoate or phthalate esters, polyalkylene oxides, sulfonamides, and the like. The plasticizers include dioctyl adipate plasticizer (DOA), triethylene glycol di-2-ethylhexanoate plasticizer (TEG-EH), trioctyl trimellitate plasticizer (TOTM), glyceryl triacetate (triacetin plasticizer), 2,2,4-trimethyl-1,3-pentanediol diisobutyrate plasticizer (TXIB), diethyl phthalate plasticizer (DEP), dioctyl terephthalate plasticizer (DOTP), dimethyl phthalate plasticizer (DMP), dioctyl phthalate plasticizer (DOP), dibutyl phthalate plasticizer (DBP), ethylene oxide, toluene sulfonamide, and dipropylene glycol benzoate. Other commercially available plasticizers may also be useful.

Useful stabilizers provide radical trapping activity and are generally selected with reference to at least some of the following considerations: the compatibility with the resin system, the temperature stability of the stabilizer at processing temperatures, whether the stabilizer will cause undesirable coloring, and that the stabilizer will not interact with other additives. Further, the stabilizer should inhibit ageing during processing, during storage and during the end use. Useful stabilizers include tert-butylhydroquinone, propyl gallate, sodium nitrate, sodium nitrite, butylated hydroxytoluene (BHT), and butylated hydroxyanisole (BHA) and analogs and derivatives. Suitable additives are commercially available from such suppliers as Ciba Specialty Chemicals, Inc. (Tarrytown, N.Y.) and Ferro Corp. (Independence, Ohio).

A tackifier may be used to induce or enhance pressure sensitive properties of the adhesive. Typical tackifiers include rosins, rosin derivatives, terpenes, synthetic tacky resins, low molecular weight polyacrylates and the like as well as mixtures thereof.

After compounding, the resulting composition can be coated on a substrate and crosslinked by irradiating the coated substrate with ultraviolet radiation. The result is an adhesive construction, for example a tape, label or similar article. The construction can be converted or otherwise processed using conventional techniques.

Non-limiting examples of techniques for coating the composition include slot die, air knife, brush, curtain, bar, extrusion, blade, floating knife, gravure, kiss roll, knife-over-blanket, knife-over-roll, offset gravure, reverse roll, reverse-smoothing roll, rod and squeeze roll coating. The coat weight generally lies within the range of about 15 to about 100 grams per square meter (gsm), and in one embodiment, within the range of about 25 to 30 gsm.

In one embodiment, the compounded adhesive is coated on a release liner, such as siliconized paper or film, crosslinked with UV radiation, and then laminated to a flexible backing, i.e., a facestock. Alternatively, the compounded adhesive is coated directly on a facestock, crosslinked with UV radiation, and then protected with a release liner.

In order to activate the anaerobic cure of the adhesive layer, the surface of the substrate to which the adhesive construction is to be applied is coated with a surface primer. The surface primers, in general, comprise at least one transition metal. Transition metals are useful in accelerating the cure mechanism of peroxide initiated acrylic anaerobic compositions. Any transition metal compound can be used provided that the compound exhibits reactivity as an activator. Reactivity is measured by the speed of cure of the anaerobic adhesive. The transition metals are those metals that have their valence electrons in a “d” subshell. Included in this group are the metals of Groups 3, 4, 5, 6, 7, 8, 9, 10 and 11 of the Periodic Table of Elements. Particularly useful transition metals include copper, chromium, manganese, iron, cobalt, nickel, and molybdenum. Alloys of these transition metals with minor amounts of other metals also can be utilized. For example, RotoStar 801-103 pigment, a bronze pigment based on 90% copper and 10% zinc is useful as an activating agent. RotoStar 801-103 pigment is available from Eckart America and contains a UV curable monomer.

The transition metal compound may be in the form of an inorganic or organometallic compound, including oxides, salts, and organometallic chelates and complexes. Suitable organic salts include the sulfates, nitrates, chlorides, bromides, phosphates and sulfides. Suitable organic salts include the alkoxides, for example, the methoxides and ethoxides, as well as the carboxylates, including the acetates, hexoates, octoates, ethylhexanoates, and naphthenlates. Other suitable transition metal complexes include the acetylacetonates and the hexafluoroacetylacetonates. Particularly useful transition metal compounds include copper 2-ethylhexanoate, copper acetate, copper naphthenate, copper octoate, copper hexoate, and copper hexafluoroacetylacetonate. The concentration of activating agent in the activating layer depends on the composition and thickness of the anaerobic adhesive layer used and should be sufficient to result in curing of the anaerobic adhesive at the edges or periphery of the label construction, where exposure to air (oxygen) is relatively greater.

The activator can be an organocopper catalyst, such as LOCTITE 7469 PRIMER, which is commercially available from Henkel Loctite Corp. In other embodiments, suitable alternative activators include organo-iron compounds, zirconium complexes (such as K-KAT XC-923), metal chelates (such as NACURE XC-9206), and antimony-based catalysts (such as NACURE XC-7231), all of which are commercially available from King Industries, Inc. Yet other suitable activators in alternative embodiments include nitrogen and sulfur based activators.

In one embodiment of the present invention, the adhesive composition comprises about 15% to about 65% by weight of a UV curable component comprising at least one acrylate functional group; about 2% to about 6% by weight of a Type II photoinitiator; about 2% to about 6% by weight of an amine synergist; about 20% to about 75% by weight of an anaerobically curable component comprising at least one methacrylate functional group; and about 0.1% to about 2% by weight of a peroxy initiator.

In another embodiment of the invention, the adhesive composition comprises about 20% to about 40% by weight of a UV curable component comprising at least one acrylate functional group; about 3% to about 5% by weight of a Type II photoinitiator; about 3% to about 5% by weight of an amine synergist; about 45% to about 65% by weight of an anaerobically curable component comprising at least one methacrylate functional group; and about 0.2% to about 1.5% by weight of a peroxy initiator.

The adhesive composition may further include a vinyl terminated liquid rubber, such as a methacrylated rubber. The rubber may be added to reduce the likelihood of crack propagation and improve flexibility of the anaerobically cured adhesive layer. The adhesive composition may comprise 0 to about 15% by weight vinyl terminated liquid rubber, or about 2% to about 10% by weight of the rubber.

### EXAMPLES

Presented below are non-limiting examples of pressure sensitive adhesives, UV-crosslinked constructions, and anaerobically cured constructions.

### Example 1

Table 1 lists a formulation that uses an intermediate cure step to produce pressure sensitive adhesive characteristics.

TABLE 1

| | Approximate Amount |
|---|---|
| Description of Ingredients | (percent of total weight) |
| LOCTITE SPEEDBONDER 326 | 50 |
| BR 3042 | 40 |
| UCB EBECRYL 7100 | 5 |
| SARCURE SR 1135 | 5 |

SPEEDBONDER 326, an anaerobic structural adhesive containing a urethane methacrylate and a peroxy initiator from Loctite; BR 3042, an aromatic difunctional polyether urethane acrylate available from Bomar Specialties Company; EBECRYL 7100, a reactive amine available from UCB Chemicals Group and SARCURE SR1135, a photoinitiator containing a blend of phosphine oxide, trimethyl benzophenone and methylbenzophenone and oligo phenyl propanones available from Sartomer Company are mixed together in the amounts listed above.

The adhesive composition is applied to a 2.0 mil clear BOPP laminate (UCB TC-CPA) on the topcoated surface using a #24 Meyer Rod (24 micrometers or microns). An ultraviolet (UV) lamp curing system is used to cure the composition to an adhesive having pressure sensitive adhesive properties. The UV lamp system includes FUSION H600 and D600 bulbs (Fusion UV Systems, Inc., Torrance, Calif.). The lamp system is operated at full power: about 240 watts/cm (600 watts/inch) and at a belt speed of about 75 feet per minute (FPM) for four passes. The resulting adhesive bonds to the surface of the substrate, is tacky and has pressure sensitive adhesive characteristics.

LOCTITE 7649 PRIMER, an acetone based copper salt activator, is sprayed onto a surface of a prepared stainless steel substrate. The BOPP film coated with the adhesive is applied to the surface of the prepared stainless steel. The adhesive maintains the BOPP substrate in adhesive contact with the stainless steel substrate due to the pressure sensitive adhesive characteristics of the adhesive. The adhesive construction is allowed to further cure for 2 days and tested again. After anaerobic cure, the adhesive has lost the tackiness associated with a pressure sensitive adhesive, and has formed the structural adhesive properties in place of the pressure sensitive adhesive characteristics.

### Example 2

An adhesive is prepared substantially in accordance with the procedure of Example 1, with the following ingredients:

TABLE 2

| | Approximate Amount |
|---|---|
| Description of Ingredients | (percent of total weight) |
| LOCTITE SPEEDBONDER 326 | 65 |
| SARTOMER 3002 | 20 |
| SARTOMER RICACRYL 3801 | 5 |
| UCB EBECRYL 7100 | 5 |
| SARCURE SR 1135 | 5 |

CN3002 is a blend of acrylic monomer and a hydrocarbon tackifier resin available from Sartomer Company. Ebecryl 7100 is an amine functional acrylate available from UCB Chemicals Group. Ricacryl 3801 is a methacrylate polybutadiene from Sartomer Company.

The adhesive composition is applied to a 2.0 mil clear BOPP laminate (UCB TC-CPA) on the topcoated surface using a #24 Meyer Rod (24 micrometers or microns). An ultraviolet (UV) lamp curing system is used to cure the composition to an adhesive having pressure sensitive adhesive properties. The UV lamp system includes FUSION H600 and D600 bulbs (Fusion UV Systems, Inc., Torrance, Calif.). The lamp system is operated at full power: about 240 watts/cm (600 watts/inch) and at a belt speed of about 75 feet per minute (FPM) for two passes. The resulting adhesive bonds to the surface of the substrate, is tacky and has pressure sensitive adhesive characteristics.

LOCTITE 7649 PRIMER, an acetone based copper salt activator, is sprayed onto a surface of a prepared stainless steel substrate. The BOPP film coated with the adhesive is applied to the surface of the prepared stainless steel. The adhesive maintains the BOPP substrate in adhesive contact with the stainless steel substrate due to the pressure sensitive adhesive characteristics of the adhesive. The adhesive construction is allowed to further cure for 20 hours and tested again. After anaerobic cure, the adhesive has lost the tackiness associated with a pressure sensitive adhesive, and has formed the structural adhesive properties in place of the pressure sensitive adhesive characteristics.

The resulting adhesive exhibits initial pressure sensitive adhesive properties when applied to a substrate that has been pretreated with a transition metal accelerator (Product 7649 from Loctite). The adhesive exhibits structural adhesive properties subsequent to an additional curing period.

The processes and embodiments described herein are examples of structures, systems and methods having elements corresponding to the elements of the invention recited in the claims. This written description may enable those skilled in the art to make and use embodiments having alternative elements that likewise correspond to the elements of the invention recited in the claims. The intended scope of the invention thus includes other structures, systems and methods that do not differ from the literal language of the claims, and further includes other structures, systems and methods with insubstantial differences from the literal language of the claims.

1. A pressure sensitive structural adhesive composition comprising:
a UV curable component comprising at least one acrylate functional group;
a Type II photoinitiator;
an amine synergist;
an anaerobic curable component comprising at least one methacrylate functional group; and
a peroxy initiator.

2. The adhesive composition of claim 1 wherein the UV curable component comprises an alkyl acrylate monomer having from about 4 to about 8 carbon atoms.

3. The adhesive composition of claim 1 wherein the UV curable component comprises a urethane acrylate oligomer.

4. The adhesive composition of claim 3 wherein the UV curable component comprises an aromatic difunctional polyether urethane acrylate oligomer.

5. The adhesive composition of claim 1 wherein the anaerobic curable component comprises an epoxy-methacrylate resin.

6. The adhesive composition of claim 1 wherein the anaerobic curable component comprises urethane-methacrylate resin.

7. The adhesive composition of claim 1 further comprising a tackifier.

8. The adhesive composition of claim 1 further comprising a vinyl terminated liquid rubber.

9. The adhesive composition of claim 8 wherein the vinyl terminated liquid rubber comprises a methacrylate terminated polybutadiene.

10. A pressure sensitive structural adhesive composition comprising:
about 15% to about 65% by weight of a UV curable component comprising at least one acrylate functional group;
about 2% to about 6% by weight of a Type II photoinitiator;
about 2% to about 6% by weight of an amine synergist;
about 20% to about 75% by weight of an anaerobic curable component comprising at least one methacrylate functional group; and
about 0.1 % to about 2% by weight of a peroxy initiator.

11. An adhesive article comprising;
a substrate having an upper surface and a lower surface; and
an adhesive layer having an upper surface and a lower surface, wherein the adhesive comprises (a) a UV curable component comprising at least one acrylate functional group; (b) a Type II photoinitiator; (c) an amine synergist; (d) an anaerobic curable component comprising at least one methacrylate functional group; and (e) a peroxy initiator, wherein the upper surface of the adhesive layer is adhered to the lower surface of the substrate.

12. The adhesive article of claim 11 further comprising a release liner releasably adhered to the lower surface of the adhesive layer.

13. A pressure sensitive adhesive construction comprising:
a first substrate having an upper surface and a lower surface;
an adhesive layer having an upper surface and a lower surface, the adhesive comprising a UV curable component and an anaerobic curable component, wherein the upper surface of the adhesive layer is adhered to the lower surface of the first substrate;
the adhesive layer providing an initial adhesion to a second substrate to be bonded and a permanent adhesion to the second substrate upon exposure to an anaerobic accelerator in the absence of oxygen.

14. The adhesive construction of claim 13 wherein the UV curable component comprises at least one acrylate functional group.

15. The adhesive construction of claim 13 wherein the UV curable component comprises at least one methacrylate functional group.

16. The adhesive construction of claim 13 wherein the second substrate is coated on at least the surface to be bonded with an anaerobic accerator.

17. The adhesive construction of claim 16 wherein the anaerobic accelerator comprises a transition metal compound or ion.

18. The adhesive construction of claim 16 wherein the anaerobic accelerator comprises an organocopper compound.

19. A method of forming a structural bond comprising:
providing a first substrate having an adhesive layer adhered thereto, the adhesive layer comprising a partially UV cured adhesive composition comprising a UV curable component and an anaerobic curable component;
applying the adhesive layer of the first substrate to a second substrate wherein the adhesive layer provides an initial adhesion to the surface of the second substrate with light pressure; and
orienting the first and second substrates to create a generally anaerobic environment wherein the adhesive layer is disposed within the anaerobic environment.

20. The method of claim 19 wherein the surface of the second substrate comprises an anaerobic cure accelerator.
